(19) United States
(12) Patent Application Publication
(10) Pub. No.: US 2025/0048509 A1
(43) Pub. Date: Feb. 6, 2025

(54) METHOD FOR DETERMINING A POWER ABSORBED BY A FOOD TO BE COOKED THAT IS SITUATED IN A COOKING CHAMBER, AND COOKING APPLIANCE AND COMPUTER PROGRAM

(71) Applicant: TOPINOX SARL, Wittenheim (FR)

(72) Inventors: Felix KIELMANN, Wittenheim (FR); Christian KOENEN, Wittenheim (FR)

(21) Appl. No.: 18/715,926

(22) PCT Filed: Nov. 22, 2022
(86) PCT No.: PCT/EP2022/082832

§ 371 Date: Jun. 3, 2024

(30) Foreign Application Priority Data
Dec. 1, 2021 (DE) 10 2021 131 619.7

(51) Int. Cl. H05B 6/64; H05B 6/80

(52) U.S. Cl. CPC H05B 6/6447; H05B 6/80

(57) ABSTRACT

Determining a power P_{GG} absorbed by a cooking product present in a cooking chamber includes:
S1. feeding electromagnetic radiation into an empty cooking chamber over a defined frequency range;
S2. detecting a frequency-dependent high-frequency property of the empty cooking chamber over the frequency range;
S3. determining a cooking chamber property Q_{empty} of the empty cooking chamber based on the detected high-frequency property;
S4. feeding electromagnetic radiation into a cooking chamber loaded with a cooking product over a defined frequency range;
S5. detecting a frequency-dependent high-frequency property of the cooking chamber loaded with the cooking product over the frequency range;
S6. determining a cooking chamber property Q_{loaded} of the cooking chamber loaded with a cooking product based on the detected high-frequency property; and
S7. determining a power P_{GG} absorbed by the cooking product from the cooking chamber properties Q_{empty}, Q_{loaded} and a power P_{eff} fed into the cooking chamber.

The invention relates to a method of determining a power absorbed by a cooking product present in a cooking chamber. The invention further relates to a cooking appliance comprising a microwave module, and to a computer program.

In professional or in canteen kitchens, cooking appliances are used which are adapted to cook a cooking product present in a cooking chamber of the cooking appliance in different ways. In addition to the conventional methods in which the cooking product is cooked by hot air and/or steam, microwave sources are often also used in modern cooking appliances, which heat the cooking product by means of electromagnetic radiation. Magnetrons and semiconductor components may be used as microwave sources.

In addition to the generation of electromagnetic radiation for cooking, the microwave sources, in particular the microwave sources formed by semiconductor components (“Solid State Microwave Generator” (SSMG)) can also be used to detect information as to the cooking product and/or the cooking accessories present in the cooking chamber. To this end, incoming and outgoing waves, in particular at the feeding points of the cooking chamber, can for example be measured using the semiconductor components and the power introduced, and the high-frequency properties of the (loaded) cooking chamber can be determined therefrom. It is in turn possible to determine, among others, specific cooking product properties and/or cooking chamber load quantities from the high-frequency properties.

From such measurements, it is however not possible so far to distinguish whether or to which extent the power introduced was absorbed in the cooking product or parasitically, for example in the walls of the cooking chamber or by a fan wheel.

The object of the invention is therefore the provision of a simple and cost-effective possibility of precisely determining a power effectively absorbed by a cooking product present in the cooking chamber, taking parasitic absorption into account.

According to the invention, the object is achieved by a method of determining a power absorbed by a cooking product present in a cooking chamber, comprising the following steps:
S1. feeding electromagnetic radiation into an empty cooking chamber over a defined frequency range;
S2. detecting a frequency-dependent high-frequency property of the empty cooking chamber over the frequency range;
S3. determining a cooking chamber property Q_{empty} of the empty cooking chamber based on the detected high-frequency property;
S4. feeding electromagnetic radiation into a cooking chamber loaded with a cooking product over a defined frequency range;
S5. detecting a frequency-dependent high-frequency property of the cooking chamber loaded with the cooking product over the frequency range;
S6. determining a cooking chamber property Q_{loaded} of the cooking chamber loaded with a cooking product based on the detected high-frequency property; and
S7. determining a power P_{GG} absorbed by the cooking product from the cooking chamber property Q_{empty} of the empty cooking chamber, the cooking chamber property Q_{loaded} of the cooking chamber loaded with a cooking product, and a power P_{eff} fed into the cooking chamber.

The basic idea of the invention is to first detect or (directly) measure high-frequency properties which can be determined in a simple and cost-effective manner for an unloaded cooking chamber, i.e. an empty cooking chamber, and a loaded cooking chamber separately from each other.

The respective high-frequency property may be a ratio of the electromagnetic waves, in particular the amplitudes of electromagnetic waves incoming or outgoing at the feeding points of the cooking chamber, for example at antennas provided for feeding in the electromagnetic energy. The high-frequency property many also be a ratio of the phases of the incoming or outgoing electromagnetic waves. The high-frequency property may in particular also be a scattering parameter S.

The corresponding electromagnetic waves which are detected are also referred to as forward electromagnetic waves or backward electromagnetic waves.

Based on the corresponding high-frequency property, a corresponding cooking chamber property Q can then be determined for the cooking chamber, in which the high-frequency property has been measured, i.e. for example in the loaded or empty state. A cooking chamber property Q may in particular be a measure for a dielectric load in the cooking chamber and/or a cooking chamber quality, i.e. the quality of the cooking chamber.

A comparison of the cooking chamber property for the empty cooking chamber Q_{empty} and the cooking chamber property for the loaded cooking chamber Q_{loaded} allows conclusions to be drawn as to which proportion of the power P_{eff} introduced into the cooking chamber is lost in the cooking chamber itself, for example by parasitic absorption, and which proportion can effectively be used to the heat the cooking product.

The power P_{eff} introduced into the cooking chamber is in particular microwave power fed in from a microwave source of the cooking appliance.

In this respect, the power P_{GG} absorbed by the cooking product is microwave power absorbed by the cooking product.

With regard to the comparison, it has in particular been noticed that a power P_{GG} effectively absorbed by the cooking product, in good approximation, may be proportional, in particular directly proportional to a power P_{eff} fed in, the proportionality constant being dependent on a ratio of the cooking chamber properties Q_{loaded}/Q_{empty}.

For example, the parameters just mentioned may be related as follows:

$${P}_{G G} = ( 1 - {Q}_{loaded} / {Q}_{empty} ) * {P}_{eff}$$

Knowledge of such a relationship makes it possible to determine the power P_{GG} effectively absorbed by the cooking product in a quick and simple manner.

It is thus also possible, for example, that the power P_{GG} effectively absorbed by the cooking product is monitored, i.e. that a so-called monitoring is carried out, to detect changes in the power absorption by the cooking product. It is thus possible to control or regulate ongoing cooking processes even more precisely so that a cooking result, for example a desired crust formation, may be improved and/or a cooking time and/or manual cooking state checks can be reduced.

In other words, real-time monitoring is possible so that it is possible to react directly to changes in the absorption properties of the cooking product.

Changes in the absorption properties may in particular arise due to changes in the geometry of the cooking product, for example a swelling of pasta or similar, and/or due to changes in the cooking product parameters of the cooking product, for example the (current) density of the cooking product, the (current) water content of the cooking product, the (current) protein coagulation of the cooking product and/or further cooking product properties.

As mentioned at the beginning, the microwave power can exclusively be used to sense the absorption behavior of the cooking product. The corresponding changes in the geometry of the cooking product and/or the changes in the cooking product parameters of the cooking product can thus result from a conventional cooking process, i.e. due to hot air and/or steam.

The determination of the cooking chamber property based on a detected high-frequency property is described, for example, in DE 10 2019 127 620 A1.

Basically, method step S7, i.e. the determination of a power P_{GG} absorbed by the cooking product based on the cooking chamber property Q_{empty} of the empty cooking chamber, the cooking chamber property Q_{loaded} of the cooking chamber loaded with the cooking product, and a power P_{eff} fed into the cooking chamber, allows the conclusion to be drawn as to which proportion of the power (P_{eff}) introduced into the cooking chamber is lost in the cooking chamber itself, for example by parasitic absorption, and which proportion can effectively be used to heat the cooking product. This information is thus made accessible and can be used to optimize cooking processes.

In contrast thereto, it is known from the prior art, for example from DE 10 2016 110 918 A1, to characterize a mass of the cooking product and to draw conclusions therefrom as to a heating power to be set. Here, the focus is on resonances, in particular on a shift in the resonances which should depend on the mass of the introduced cooking product.

However, this does not lead to the idea according to the invention to establish a correlation between the power fed in (P_{eff}) and the power (P_{GG}) (effectively) absorbed by the cooking product or the energy via the cooking chamber properties of the empty cooking chamber (Q_{empty}) and the loaded cooking chamber (Q_{loaded}).

In other words, it can actually be determined which energy is absorbed by the cooking product, parasitic absorption of the cooking chamber being taken into account, for example the absorption by the walls of the cooking chamber.

One aspect provides that the high-frequency property respectively determined in steps S2 and S5 is a scattering parameter S. Scattering parameters S are relatively simple to determine, namely using incoming or outgoing electromagnetic waves. Furthermore, in many modern cooking appliances having a microwave source, the scattering parameters are anyway detected as a standard for heating regulation purposes.

In a preferred embodiment, the cooking chamber properties Q_{empty} and Q_{loaded} may be deterministic measures. Particularly preferably, the entire method can therefore be purely deterministic, which means that it does not require any statistical and/or stochastic evaluation steps at all. Consequently, the method is accordingly quick and adapted to be realized with little evaluation or calculation effort. The required computing power can thus be reduced.

In one embodiment which is technically simple to implement, the cooking chamber properties Q_{empty} and Q_{loaded} may be calculated in steps S3 and S6 for example by deriving the high-frequency properties detected in steps S2 and S5 with respect to the frequency, and by integrating the derivation results. Compared to the determination of the cooking properties by means of statistical methods or using artificial intelligence, the calculation effort and/or the calculation time can thus be reduced.

The integration is in particular a numerical integration of the high-frequency property derived with respect to the frequency, i.e. the function thereof. This can be carried out using the trapezoidal rule. The numerical integration can be used to map the vibration behavior of the high-frequency property onto a real number, which can thus be used as a deterministic measure.

In general, the respective cooking chamber property of the empty or loaded cooking chamber can be determined by forming a magnitude function of the function of the high-frequency property derived with respect to the frequency, to obtain a function of the magnitude of the function of the high-frequency property which is derived with respect to the frequency, which is integrated, in particular wherein the magnitude of the function derived with respect to the frequency is integrated numerically.

Preferably, the cooking chamber properties for Q_{empty} and Q_{loaded} characterize dielectric loads of the cooking chamber, in particular based on real numbers. An empty cooking chamber also represents a corresponding dielectric load, namely due to the parasitic absorption. It has been found that a precise determination of the power P_{GG} absorbed by the cooking product is also possible without having to determine the numerous boundary conditions in advance, such as the distribution of electromagnetic waves or fields in the cooking chamber, the shape and/or the position of the cooking product. This is because all these influencing factors are taken into account in the cooking chamber properties Q_{empty} and Q_{loaded} determined from the high-frequency properties.

According to one aspect of the method, the power P_{GG} absorbed by the cooking product can be determined in step 7 in a technically simple manner, among others using a quotient of the cooking chamber properties Q_{empty} and Q_{loaded}.

Alternatively, a relationship can also be determined between the power P_{eff} fed in and the power P_{GG} absorbed by the cooking product from the determined cooking chamber properties Q_{empty} and Q_{loaded} using pattern recognition, in particular artificial intelligence, for example to further improve the accuracy of the method.

Furthermore, it may be provided that the cooking chamber properties Q_{loaded} for a cooking chamber loaded with a cooking product are determined in step S6 continuously and/or at regular time intervals during a cooking process. If the dielectric properties of a cooking product change during a cooking process, for example by protein coagulation, evaporation, a surface change and/or a change in geometry, this may change the proportion of the radiated microwave power absorbed by the cooking product. This change can be tracked by monitoring the properties of the loaded cooking chamber Q_{loaded} over time, and therefore, a cooking progress of the cooking product can for example be precisely determined.

It may thus be provided that a change over time of the cooking chamber property Q_{loaded} of the cooking chamber loaded with the cooking product is determined.

In a further aspect of the method, the electromagnetic radiation fed into the cooking chamber in step S1 is only used for determining the power P_{GG} absorbed by the cooking product. In this respect, the power of the introduced microwaves (electromagnetic radiation) may have a value which is unsuitable for cooking the cooking product, as it is too low. Such a power is referred to as sensor power which is exclusively used for sensing.

In contrast thereto, conventional techniques such as convection are used to cook to cooking product. It is for example possible to feed microwave radiation into the loaded cooking chamber to determine the power P_{GG} absorbed by the cooking product during a convection-driven cooking process using the method according to the invention, and to monitor the change thereof to thus draw conclusions as to the cooking state of the cooking product during the cooking process.

In principle, it may however also be provided that electromagnetic radiation is provided for cooking the cooking product, for example in addition to conventional techniques or even as the only energy supply for cooking the cooking product.

A corresponding microwave source can switch back and forth between a sensor mode and a heating mode, in particular wherein the sensor mode takes place periodically to periodically detect a change in the cooking product. This is possible by detecting the change in the power P_{GG} absorbed by the cooking product using the cooking chamber property Q_{empty} of the empty cooking chamber, the cooking chamber property Q_{loaded} of the cooking chamber loaded with the cooking product, and the power P_{eff} fed into the cooking chamber.

In an advantageous variant embodiment, the method is thus suitable for use in combi-appliances comprising a plurality of energy sources for heating cooking products, one of the energy sources being preferably a microwave source, in particular a semiconductor-based microwave source, by means of which electromagnetic radiation can be fed into a cooking chamber both for cooking and for determining a power P_{GG} absorbed by the cooking product, namely in the sensor mode.

According to a further aspect, the cooking chamber property/properties Q_{empty} and/or Q_{loaded} may be stored in a database, steps S1 to S6 being in particular performed in a test device, and the cooking chamber property/properties Q_{empty} and/or Q_{loaded} determined therefrom and stored in the database being used to determine, in step S7, the power P_{GG} absorbed by a cooking product present in the cooking chamber of the cooking appliance, the cooking appliance being different from the test device.

Once values have been measured on the test device and stored, for example a cooking chamber property Q_{empty} of a specific unloaded cooking chamber, they can thus be easily transmitted to other cooking appliances, in particular to cooking appliances having a cooking chamber of the same type, i.e. cooking appliances of identical design at least with regard to the cooking chamber. As a result, steps S1 to S3 for the determination of a power P_{GG} absorbed by a cooking product do not have to be carried out again for each cooking process. This simplifies and accelerates the process and also improves the user friendliness.

It is basically possible to implement a microwave-energy meter which indicates how much energy is absorbed by the cooking product present in the cooking chamber. To this end, the power P_{GG} absorbed by the cooking product is detected by means of the described method, in particular during a microwave cooking mode, in which the microwave radiation at least supports the cooking of the cooking product.

The microwave-energy value thus determined and provided by the microwave-energy meter can be output to the user of the cooking product, so that the user is informed of the energy additionally introduced by the microwave source into the cooking product, i.e. the corresponding energy effectively absorbed by the cooking product. The corresponding value can be output in kilojoules (KJ), a unit based on Kilojoules, or as a percentage of the total energy to be introduced, such that the cooking product has the desired cooking result in terms of energy supply.

Furthermore, the power can be regulated to the (effectively) absorbed power of the cooking product during the ongoing cooking process.

Furthermore, the object is achieved according to the invention by a cooking appliance comprising a cooking chamber, at least one microwave module configured and set up to feed electromagnetic radiation into the cooking chamber, and a control and/or evaluation unit configured and set up to perform or initiate a method of the type described above.

The object is also achieved according to the invention by a computer program comprising program code means to carry out at least the determination of the cooking chamber property Q_{empty} of the empty cooking chamber in step S3, the determination of the cooking chamber property Q_{loaded} of the loaded cooking chamber in step S6, and/or the determination of a power P_{GG} absorbed by the cooking product in step S7 of a method according to the invention when the computer program is executed by means of a computing unit, in particular a control and/or evaluation unit of the cooking appliance.

The advantageous and features discussed with respect to the method of course also apply accordingly to the cooking appliance and the computer program according to the invention.

Further features and advantages of the invention will become apparent from the description below and from the drawings to which reference is made and in which:

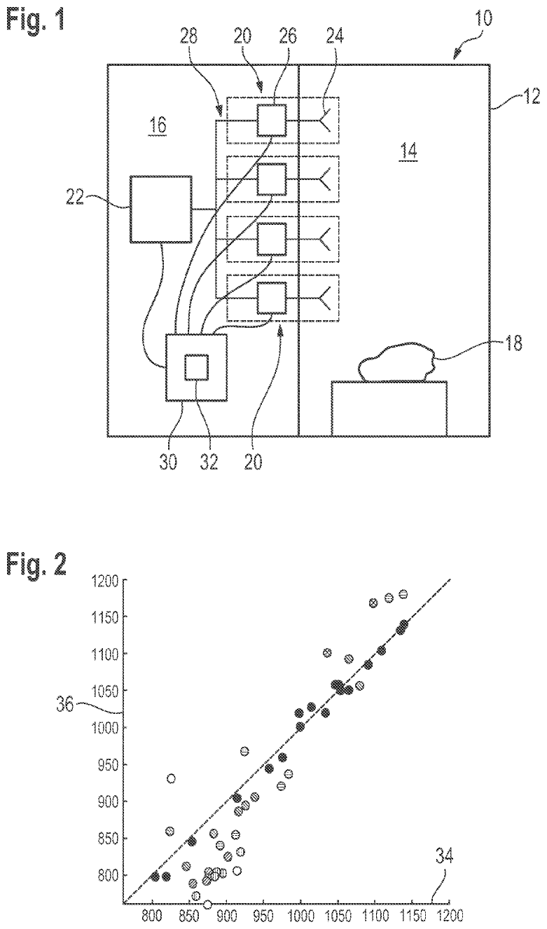

FIG. 1 shows a schematic view of a cooking appliance according to the invention;

FIG. 2 shows a diagram in which a measured absorbed power of the cooking product is plotted against an absorbed power of a cooking product expected by calculation;

FIG. 3 shows a schematic view of a cooking chamber of a cooking appliance with a cooking accessory loaded with fried eggs; and

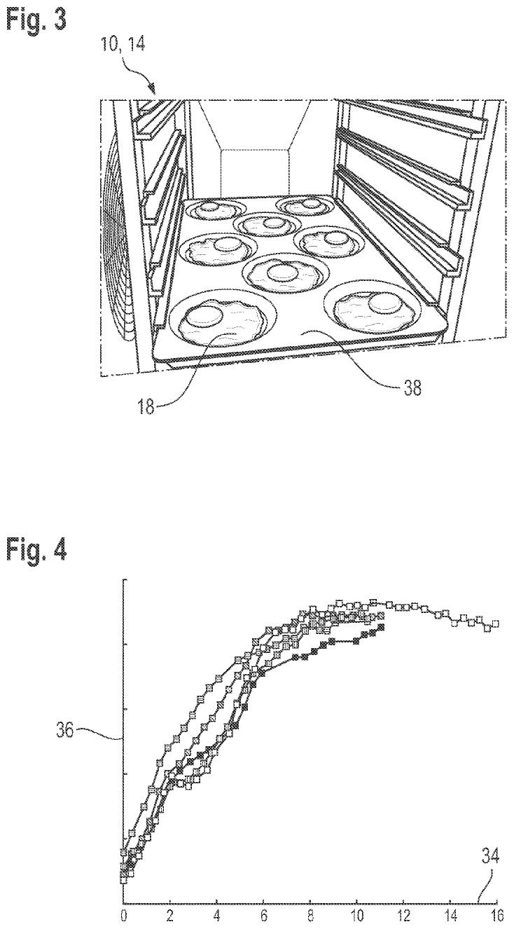

FIG. 4 shows a diagram in which powers absorbed by the fried eggs from FIG. 3 from several tests are plotted over time.

FIG. 1 shows a cooking appliance 10 having a housing 12 which surrounds a cooking chamber 14 and a technical chamber 16.

A cooking product 18 which is to be cooked in the cooking appliance 10 is introduced into the cooking chamber 14.

To this end, the cooking appliance 10 comprises in addition to another heating device not represented here, a plurality of microwave modules 20 which, in the embodiment shown, are connected to a microwave generator 22 which is configured as a semiconductor component and serves as a (coherent) microwave source.

Alternatively, each microwave module 20 may have an own microwave generator 22 assigned thereto.

The microwave modules 20 are configured to feed electromagnetic radiation into the cooking chamber 14. To this end, each microwave module 20 has an antenna 24, a directional coupler 26, and a microwave inlet 28 through which the microwave module 20 receives microwaves (electromagnetic radiation) from a microwave generator 22.

In the structure outlined in FIG. 1, the directional couplers 26 of the respective microwave modules 20 allow a separate measurement of the incoming and outgoing electromagnetic waves at the respective feeding points in that these are (at least partially) accordingly decoupled separately from each other by means of the directional couplers 26.

Furthermore, the microwave modules 20 can comprise further components or parts, for example a modulator, an amplifier, a demodulator and/or a controller.

In addition, the cooking appliance 10 comprises a control and/or evaluation unit 30 which is connected to the microwave generator 22 and to the respective microwave modules 20. The incoming and outgoing electromagnetic waves decoupled separately from each other by the directional couplers 26 are forwarded to the control and/or evaluation unit 30 for evaluation.

The control and/or evaluation unit 30 is set up to calculate a high-frequency property by evaluating the incoming or outgoing electromagnetic waves.

In addition, the control and/or evaluation unit 30 is set up to determine the cooking chamber property of the cooking chamber 14 using the detected high frequency.

Optionally, the control and/or evaluation unit 30 can comprise a recognition device 32 which is set up to perform a pattern recognition for the cooking chamber property. In this way, a cooking product 18 introduced into the cooking chamber 14 can be recognized, for example on the basis of the determined cooking chamber property of the cooking chamber 14.

The control and evaluation unit 30 illustrated in FIG. 1 is configured to execute a method of determining a power P_{GG} absorbed by the cooking product 18 or to cause the cooking appliance 10 to execute it.

To this end, the control and/or evaluation unit 30 executes a computer program having program code means, in particular on a computing unit of the control and/or evaluation unit 30, to determine the cooking chamber property of the empty cooking chamber Q_{empty} and the cooking chamber property Q_{loaded} of the loaded cooking chamber 14, which are used to determine a power P_{GG} absorbed by the cooking product 18. A power P_{eff} fed into the cooking chamber 14 is additionally used to determine the power P_{GG} effectively absorbed by the cooking product 18, as will be explained in detail below.

To determine the power P_{GG} effectively absorbed by the cooking product 18, electromagnetic radiation is in a first step initially fed into an empty cooking chamber 11 over a defined frequency range by means of the microwave generator 22 and the antennas 24.

In a second step S2 of the method, a frequency-dependent high-frequency property of the empty cooking chamber 14 is determined over the frequency range. The frequency-dependent high-frequency property may in particular be at least one scattering parameter S which is detected at the antennas 24, i.e. the feeding points. To determine the at least one scattering parameter S, the forward electromagnetic waves and the backward electromagnetic waves can be decoupled accordingly by means of the assigned directional couplers 26, so that they can be used for determining the at least one scattering parameter S.

In a third step S3 of the method, a cooking chamber property Q_{empty} of the empty cooking chamber 14 is determined based on the high-frequency property detected in step S2. This is carried out, for example, by deriving the high-frequency property with respect to the frequency over the entire detected frequency range and then by numerically integrating the function obtained, i.e. the derivation result.

The derivation in particular allows an evaluation of the change behavior of the high-frequency property with respect to the frequency, or, expressed figuratively, of slopes in a plot of the high-frequency property (in the example embodiment S) against the frequency.

By the subsequent numerical integration, the change behavior of the high-frequency property with respect to the frequency can be summarized in one or more characteristic values, in particular in the form of real numbers. This results in a deterministic measure for the cooking chamber property of the empty cooking chamber 14.

In the example embodiment, the determined numerical values and/or values derived therefrom are characteristic of the dielectric properties of the (empty) cooking chamber 14. They thus reflect a cooking chamber property Q_{empty} of the empty cooking chamber 14. In the example embodiment, Q_{empty} is in particular characteristic of the absorption losses in the cooking chamber 14, for example in walls of the cooking chamber or a fan wheel.

Once the value Q_{empty} has been determined, the cooking chamber 14 is loaded.

The value Q_{empty} may also have been determined previously, in particular once, and stored in a memory of the cooking appliance 10. Consequently, the value Q_{empty} can also have been determined in a cooking appliance other than that loaded with the cooking product 18.

In any case, steps S1 to S3 of the method are carried out to determine the cooking chamber property Q_{empty} of the empty cooking chamber 14.

In a fourth step S4 of the method, electromagnetic radiation is fed into a cooking chamber 14 loaded with a cooking product 18 over a defined frequency range by means of antennas 24.

This may be the cooking chamber 14 of the same cooking appliance 10 for which the cooking chamber property Q_{empty} of the empty cooking chamber 14 has been previously determined. Accordingly, electromagnetic radiation is again fed into the cooking chamber 14 now loaded with the cooking product 18 over a defined frequency range by means of the same antennas 24.

However, is may also be a different cooking chamber 14, in particular the cooking chamber 14 of a different cooking appliance 10, which is of identical design, at least with regard to the cooking chamber 14, to the cooking appliance 10 for the cooking chamber 14 of which the cooking chamber property Q_{empty} has been previously determined.

In a fifth step S5, a frequency-dependent high-frequency property of the loaded cooking chamber 14 is then determined over the frequency range.

Similar to step S2 of the method, this may in particular involve at least one scattering parameter S.

The frequency range detected in step S5 is preferably identical to that of step S2. This results in a better comparability.

In a sixth step S6 of the method, a cooking chamber property Q_{loaded} of the cooking chamber 14 loaded with the cooking product 18 is then determined on the basis of the high-frequency property detected in step S5.

Similar to step S3, this is carried in the example embodiment for example by deriving the high-frequency property with respect to the frequency over the entire detected frequency range and then by numerically integrating the function thus obtained, i.e. the derivation result.

As a result, a cooking chamber property Q_{loaded} characteristic of the dielectric load of the filled cooking chamber 14 is thus obtained from step S6.

Both Q_{empty} and Q_{loaded} may in particular be deterministic measures which can be represented as real numbers and can preferably be directly compared with each other.

In this respect, the determined cooking chamber properties are deterministic measures which can thus easily be compared with each other.

In a final seventh step S7, the power P_{GG} absorbed by the cooking product 18 is determined on the basis of the cooking chamber properties Q_{empty}, Q_{loaded} and the power P_{eff} fed into the cooking chamber 14.

The power P_{eff} fed into the cooking chamber 14 can be predetermined or set via the control and/or evaluation unit 30 which drives the microwave generator 22 accordingly.

In the example embodiment, the determination is carried out by calculating the quotient of Q_{empty} and Q_{loaded} on the basis of the formula P_{GG}=(1−Q_{loaded}/Q_{empty})*P_{eff}.

The calculation rule used in the example embodiment is based on the findings that the power P_{GG} effectively absorbed in the cooking product 18 is in directly proportional relationship with the power P_{eff} fed in, the proportionality constant being determined by a ratio of the cooking chamber properties Q_{loaded}/Q_{empty}.

FIG. 2 confirms these findings. The figure shows the graphical evaluation of a series of tests in which water was heated in a cooking appliance 10 as a surrogate for the cooking product.

Values as calculated according to the above formula for the expected absorbed power of the water in Watt is plotted on the abscissa 34. The calculation was carried out on the basis of scattering parameters determined in advance.

Real absorbed power values of the water in Watt which have been determined using a temperature measurement of the water and the known properties (heat capacity) of water, are plotted on the ordinate.

The individual dots in FIG. 2 represent individual tests in which parameters such as the amount of water were varied.

In a preferred variant of the method, method steps S4, S5 and S6 are performed continuously during an ongoing cooking process or repeated at regular intervals, i.e. carried out periodically. The cooking chamber property Q_{loaded} of the cooking chamber 14 loaded with the cooking product 18 and thus also the power P_{GG} absorbed by the cooking product 18 can be monitored during a cooking process, in particular in real time. This is also referred to as (real-time) monitoring.

Due to the (real-time) monitoring, a regulation of the power feeding, be it microwave feeding or conventional heating power, can be regulated accordingly during the cooking process, the regulation being carried out on the basis of the microwave power P_{GG} effectively absorbed by the cooking product 18 during the cooking process.

This is particularly advantageous if changes in the cooking chamber property Q_{loaded} are to be expected during the cooking process.

FIG. 3 shows such a case, namely a cooking chamber 14 of a cooking appliance 10 according to the invention loaded with fried eggs as a cooking product 18.

In the example shown, microwave modules 20 present in the cooking appliance 10 are used only for sensing scattering parameters, and the fried eggs are cooked only by hot air.

FIG. 3 also shows that the precise determination of field distributions in the cooking chamber 14 can be very difficult due to complex geometries of cooking products 18 and/or of carriers 38 for cooking products. Advantageously, such a step can be omitted in the method according to the invention.

FIG. 4 shows powers P_{GG} absorbed by fried eggs during the cooking process on the ordinate 36 over time in minutes on the abscissa 34.

The diagram shows a plurality of test series carried out with the cooking appliance 10 and the appropriate set-up of FIG. 3 and in which a power P_{eff} of 1000 W was respectively assumed.

The values for P_{GG} plotted in FIG. 4 have been determined using the method according to the invention.

It can be seen from the individual graphs shown in the diagram of FIG. 4 that the power P_{GG} absorbed by the fried eggs during the cooking process rises with time. Such a change can for example be caused by a change in the properties of the cooking product and thus in the dielectric load of the loaded cooking chamber 14 during the cooking process, for example due to protein coagulation or evaporation.

The knowledge of the power P_{GG} effectively absorbed by the cooking product 18 during the cooking process as obtained with the method according to the invention can in particular be used to optimize recipes and improve cooking results.

To carry out the method, it is not necessary that all method steps are performed in one or by a single cooking appliance 10, as already explained above.

In particular, example embodiments are conceivable, in which the cooking chamber property/properties Q_{empty} and/or Q_{loaded} are/is determined using a test device, for example a reference device.

It can then be provided that individual steps, in particular steps S1 to S3, are carried out on one or several test device(s) to determine the cooking chamber property/properties Q_{empty} and/or Q_{loaded} and store them in a database.

The values can then be transmitted to a cooking appliance 10 as shown in FIG. 3, which then performs steps S4 to S7 to determine a power P_{GG} absorbed by the cooking product 18, for example the fried eggs shown.

As an alternative to the microwave generator 22 configured as a semiconductor component, a magnetron can also be provided which serves as a microwave source.

Basically, the cooking appliance 10 thus has a microwave source which is provided for feeding in electromagnetic radiation.

1-10. (canceled)

11. A method of determining a power P_{GG} absorbed by a cooking product present in a cooking chamber, comprising the following steps:
S1. feeding electromagnetic radiation into an empty cooking chamber over a defined frequency range;
S2. detecting a frequency-dependent high-frequency property of the empty cooking chamber over the frequency range;
S3. determining a cooking chamber property Q_{empty} of the empty cooking chamber based on the detected high-frequency property;
S4. feeding electromagnetic radiation into a cooking chamber loaded with a cooking product over a defined frequency range;
S5. detecting a frequency-dependent high-frequency property of the cooking chamber loaded with the cooking product over the frequency range;
S6. determining a cooking chamber property Q_{loaded} of the cooking chamber loaded with a cooking product based on the detected high-frequency property; and
S7. determining a power P_{GG} absorbed by the cooking product from a power P_{eff} fed into the cooking chamber and a quotient of the cooking chamber property Q_{empty} of the empty cooking chamber and the cooking chamber property Q_{loaded} of the cooking chamber loaded with a cooking product.

12. The method according to claim 11, wherein the high-frequency property respectively determined in steps S2 and S5 is a ratio of the electromagnetic waves incoming and outgoing at the feeding points of the cooking chamber.

13. The method according to claim 11, wherein the high-frequency property respectively determined in steps S2 and S5 is a scattering parameter S.

14. The method according to claim 11, wherein the cooking chamber properties Q_{empty} and Q_{loaded} are deterministic measures.

15. The method according to claim 11, wherein the cooking chamber properties Q_{empty} and Q_{loaded} are calculated in steps S3 and S6 by deriving the high-frequency properties detected in steps S2 and S5 with respect to the frequency and integrating the derivation results.

16. The method according to claim 11, wherein the cooking chamber properties Q_{empty} and Q_{loaded} characterize dielectric loadings of the cooking chamber, in particular based on real numbers.

17. The method according to claim 11, wherein the power P_{GG} effectively absorbed in the cooking product is related directly proportionally with the power P_{eff} fed in, the quotient of the cooking chamber property Q_{empty} of the empty cooking chamber and the cooking chamber property Q_{loaded} of the cooking chamber loaded with the cooking product being a proportionality constant.

18. The method according to claim 11, wherein the power P_{GG} absorbed by the cooking product is determined using the formula: P_{GG} (1−Q_{loaded}/Q_{empty})*P_{eff}.

19. The method according to claim 11, wherein the cooking chamber properties Q_{loaded} for a cooking chamber loaded with a cooking product are determined in step S6 continuously and/or at regular time intervals during a cooking process.

20. The method according to claim 11, wherein the electromagnetic radiation fed into the cooking chamber in step S1 is used exclusively for determining the power P_{GG} absorbed by the cooking product.

21. The method according to claim 11, wherein the power is regulated to the power P_{GG} absorbed by the cooking product during the ongoing cooking process.

22. The method according to claim 11, wherein the cooking chamber property/properties Q_{empty} and/or Q_{loaded} is/are stored in a database.

23. The method according to claim 22, wherein steps S1 to S6 are performed in a test device and in that the cooking chamber property/properties Q_{empty} and/or Q_{loaded} determined therefrom and stored in the database is/are used to determine, in step S7, the power P_{GG} absorbed by a cooking product present in the cooking chamber of the cooking appliance, the cooking appliance being different from the test device.

24. A cooking appliance comprising a cooking chamber, at least one microwave module configured and set up to feed electromagnetic radiation into the cooking chamber, and a control and/or evaluation unit configured and set up to perform or initiate a method according to claim 11.

25. A computer program comprising program code to carry out at least the determination of the cooking chamber property Q_{empty} of the empty cooking chamber in step S3, the determination of the cooking chamber property Q_{loaded} of the loaded cooking chamber in step S6 and/or the determination of a power P_{GG} absorbed by the cooking product in step S7 of a method according to claim 11, when the computer program is executed by a computing unit.
